(19) United States
(12) Patent Application Publication
(10) Pub. No.: US 2008/0021744 A1
(43) Pub. Date: Jan. 24, 2008

(54) METHOD OF PROVIDING FOR A PERIODIC INCOME STREAM CONDITIONED ON THE AGE AT DEATH OF THE INSURED

(76) Inventors: Philip Walker, Midlothian, VA (US); Robert Hunt, Glen Allen, VA (US)

Correspondence Address: Brian J. Teague;John H. Thomas, P.C., 536 Granite Avenue, Richmond, VA, 23226, US

(21) Appl. No.: 11/737,213

(22) Filed: Apr. 19, 2007

Related U.S. Application Data
(60) Provisional application No. 60/797,981, filed on May 5, 2006.

(51) Int. Cl. G06Q 40/00

(52) U.S. Cl. 705/4

(57) ABSTRACT

A method of providing for a future stream of payments solely to a beneficiary who survives an insured utilizes the current age of the insured to define a premium for providing funding for the potential future liability for such payments until a specific future date.

### CROSS-REFERENCE TO RELATED APPLICATIONS

This application claims priority to U.S. Provisional Application No. 60/797,981, filed May 5, 2006, the contents of which are incorporated herein in its entirety.

### FIELD OF THE INVENTION

This invention relates generally to a method for administering a program to provide benefits to beneficiaries who survive respective insureds. More specifically, the present invention relates to a method of providing for a future stream of payments from the date of death of the insured to a specific future date to a beneficiary or beneficiaries who survive(s) an insured, wherein such payments are derived from premiums paid in response to conditions including the age of the insured, from which life expectancy is measured, and the insured's age at death, from which the required number of future payments is calculated.

### BACKGROUND OF THE INVENTION

Traditionally, life insurance products have been utilized to provide financial support to beneficiaries upon the death of the insured These products offer a degree of security through the knowledge that beneficiaries will receive financial compensation that may alleviate funeral expenses as well as the absence of a source of income.

Upon commencement of a life insurance policy, a desired payment upon death is established and then payments in the form of premiums are scheduled for a fixed amount of time. There are two primary types of life insurance: permanent (also termed whole or universal) life insurance, and term life insurance. A principal difference between the two is that consumer payments of permanent life insurance premiums accrue redeemable value during the pendency of the policy, whereas term life insurance premiums typically cost less but accrue no redeemable value during the life of the policy. A second difference between term and permanent life insurance policies is that term policy payments may increase over the period of premium payments, whereas permanent life premium payments are generally fixed over the period of premium payment. However, both types of life insurance policies distribute either a lump-sum payment or a series of payments representing distribution of a lump sum plus accumulated interest over time to a beneficiary or to the estate of the insured upon the death of the insured.

The largest problem with these approaches involves the calculation of the lump sum coverage amount. To estimate a lump sum, agents must gather detailed financial information regarding present and future plans of the insured, incorporate estimates of investment returns and future inflation rates, and use this information to reduce the anticipated cash stream needs to a single lump sum.

Policies which denominate coverage in lump sum or face value terms burden the customer with the responsibility of determining what amount of coverage will be adequate. In essence this requires that prospective policy owners estimate the likely time of death of the insured, the needs of the beneficiaries from that date forward, prevailing investment returns over the course of the period during which benefits are invested, and some measure of inflation both prior to and following death. These inputs are used to generate a face amount for the policy which is the present value of all future needs, adjusted for inflation and discounted at the estimated interest rates. Of course, as time passes and the estimated values for these inputs change, policy owners must manually readjust coverage to reflect the new understanding. Once benefits have been disbursed, no further adjustment is possible and beneficiaries carry 100% of the risk for variability in these inputs.

For example, a 40 year-old woman who wishes to ensure that her spouse and children are financially comfortable may choose to purchase insurance sufficient to provide for her current gross income assuming she were to die immediately. One, admittedly costly, approach would be to secure coverage equal to the sum of her expected future earnings through retirement. If she has what she feels to be reliable estimates of future inflation and investment returns, she can improve her estimate by contracting for coverage which incorporates these estimates and which provides sufficient capital to meet income needs should these estimates prove correct. Of course, she is highly unlikely to die immediately after signing the policy. Improving on this estimate therefore requires that she estimate when she will die.

This approach presents a number of issues for the insured in that it is mathematically unintelligible to many insured individuals, time consuming to develop and explain, and very likely inaccurate in view of the difficulties in assessing future financial performance and any individual's future date of death. A related issue is that lump sum payments may require that the beneficiary budget funds appropriately in order to maintain the stream of income originally anticipated in the needs analysis. Another issue is that the changing needs of the insured and beneficiaries over time must be evaluated periodically, and the lump sum recalculated, to monitor whether over- or under-insurance is present.

One alternative approach is to utilize what is termed “decreasing term insurance” in which a high initial payout declines over time as the customer's income replacement need declines. This type of approach has been utilized in combination with permanent life policies to provide a “family income benefits.” However, these types of products do not alleviate the need to calculate the appropriate initial face value, do a generally poor job of matching the non-linear change in the present value of future payments, and do not alleviate the investment risk faced by benficiaries. As a result, while decreasing term products are more financially efficient, when offered independent of permanent insurance, they are unlikely to be significantly more satisfying, well-understood or accurate.

The challenges in accurately predicting need, while optimizing premium payments, have not been addressed by prior art life insurance programs and policies. In view of the foregoing, there is the need for a new method by which a wage earner can provide for future payments for their beneficiary(ies) at a lesser burden than by using the aforementioned traditional methods, whereby future financial security can be more readily and predictably attained.

### BRIEF SUMMARY OF THE INVENTION

The present invention overcomes the above-noted and other shortcomings of the prior art by providing a novel and improved method for administering a program to provide benefits to beneficiaries who survive respective insureds. The presently claimed invention addresses the difficulties in matching consumer needs for income protection until retirement, as a means to adequately support beneficiaries upon the loss of an income source due to a premature death. More particularly, the present invention provides a method of providing for a future stream of payments (e.g., monthly payments) to a beneficiary(ies) who survives an insured, wherein such the number of such payments is derived from the date of death of the insured and the specific future date through which the insured was covered. Basing the methodology on replacement of a specific amount of income (payment) over a period dependent on the date of death of the insured and some future, fixed date results in relatively lower pricing, lower capital reserves and a more certain future for the beneficiary(ies).

In one embodiment of the invention, a method of providing periodic monetary payments to a beneficiary who survives an insured comprises the steps of: identifying a plurality of actuarial factors for the insured; determining for the insured, by correlating actuarial mortality data with the identified actuarial factors, a periodic premium amount sufficient to enable provision of periodic monetary payments to the beneficiary beginning at a death of the insured and ending at a predetermined future date; receiving, periodically, payments of the determined premium amount; determining a date of death of the insured; and providing periodic monetary payments to the beneficiary until the earlier of (1) the predetermined future date or (2) a date at which a predetermined monetary payment maximum has been provided.

The periodic monetary payments may be further provided at least until a date at which a predetermined monetary payment minimum amount has been provided or until a date at which a predetermined minimum number of monetary payments has been provided. The premium amount may be received periodically until the earliest of the date of death of the insured, the date of death of the beneficiary, a coverage period end date, or a desired payment end date.

The method may further comprise the step of: retaining at least a portion of the received premium payments in a financial reserve from which the periodic monetary payments is made. The predetermined monetary payment maximum may correspond to one of a predetermined maximum number of payments or a predetermined maximum total payment amount. The predetermined future date may correspond to a predetermined retirement age of the insured.

The periodic monetary payments may be based on at least one of (1) an income of the insured, (2) an amount of a paycheck of the insured, (3) an amount deposited into a direct deposit account of the insured, or (4) an expense of the insured. The amount of the periodic monetary payments to be provided to the beneficiary may be either (1) determined and fixed at a time when the periodic premium amount is determined, (2) periodically revised between the time when the periodic premium amount is determined and the date of death of the insured and fixed at the date of death of the insured, (3) periodically revised until the date of death of the beneficiary. The periodic revisions may be based on at least one of (1) changes in the income of the insured, (2) changes in the amount of the paycheck of the insured, (3) changes in the amount deposited into a direct deposit account of the insured, (4) changes in the expense of the insured, or (5) inflation.

The method may further comprise the step of; revising the periodic premium amount if the amount of the periodic monetary payments is revised. The determination of the periodic premium amount may provide for the payment of a mathematical sum of all received payments of the premium amount if the insured survives past a predetermined date.

A plurality of actuarial factors may be identified for a plurality of insureds, such that a periodic premium amount may be determined sufficient to enable provision of periodic monetary payments to a respective beneficiary beginning at a death of a respective insured and ending at a predetermined future date. The payments of the determined premium amount may be received from a payor associated with all of the plurality of insureds. The actuarial data used in determining the premium amount may include data regarding a group with which the plurality of insureds is associated.

In another embodiment of the invention, a method of providing periodic monetary payments to a beneficiary who survives an insured comprises the steps of: identifying a plurality of actuarial factors for the insured; identifying, from the insured, a desired periodic premium amount; determining for the insured, by correlating actuarial mortality data with the identified actuarial factors, a periodic monetary payment amount to be provided to the beneficiary beginning at a death of the insured and ending at a predetermined future date; receiving, periodically, payments of the identified premium amount; determining a date of death of the insured; and providing the determined periodic monetary payments to the beneficiary until tile earlier of (1) the predetermined future date (2) a date at which a predetermined monetary payment maximum has been provided.

The determined periodic monetary payments may be further provided at least until a date at which a predetermined monetary payment minimum amount has been provided or until a date at which a predetermined minimum number of monetary payments has been provided. The premium amount may be received periodically until the earliest of the date of death of the insured, the date of death of the beneficiary, a coverage period end date, or a desired payment end date.

The method may further comprise the step of: retaining at least a portion of the received premium payments in a financial reserve from which the periodic monetary payments is made. The predetermined monetary payment maximum may correspond to one of a predetermined maximum number of payments or a predetermined maximum total payment amount. The predetermined future date may correspond to a predetermined retirement age of the insured.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flow chart of a method for providing a periodic income stream, in accordance with one embodiment of the present invention; and

FIG. 2 is a flow chart of a method for providing a periodic income stream, in accordance with an alternative embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

In embodiments presented herein, the presently claimed invention provides systems, methods, and products reflecting income protection for providing a stream of income to one or more beneficiaries upon the death of the insured. In contrast to prior art life insurance programs, the embodiments of the presently claimed invention overcome the need to develop an estimate of the present value of future needs and to re-evaluate the changing needs of the insured and/or beneficiaries for the duration of a policy while placing all of the interest rate and timing risk on the insurer instead of the beneficiary. Therein, the embodiments of the presently claimed invention contemplate an income protection product that provides benefit payments through a fixed future date, typically the date of anticipated retirement. Thus, an income protection product of the presently claimed invention would closely align with consumer financial need over the period of premium payments and policy duration without vulnerability to changes in interest rate or investment yield assumptions and without exposure to varying needs based on date of death. The present invention therefore provides for more efficient and flexible coverage of at-risk income.

With regard to the aforementioned example of the choices previously available to a person attempting to cover their risk with insurance with a lump-sum benefit amount, that person can now select the more affordable income protection insurance policy and choose to either pay less for coverage or purchase greater coverage for the same premium. For equivalent risk and initial coverage amounts, the present invention premium may be 50% of the level term premium for a policy of equivalent term. Moreover, the present-value of payments to the beneficiary declines over time with the result that amount at risk declines and periodic cash flows vary in such a manner as to cause the amount of regulatory capital held by the insurer to be just 20% of that held for a term product providing equivalent initial protection.

The present invention is a method for administering a program to provide benefits to beneficiaries who survive respective insureds. The specific method of the invention provides for a future stream of payments to beneficiaries. This is accomplished in a particular implementation by creating an income protection life insurance policy conditioned on life expectancy of the insured and the desired size of periodic payments to be provided to beneficiaries. In one embodiment of the invention, the basis for the periodic payments is assumed to be individual or household income; however, the present invention can be applied to other economic conditions or fixed expenses that required regular payments post-mortality (e.g., education savings or tuition) so that it is not limited to the aforementioned specific assumption. The present invention is also not limited to an individual life insurance product as the method of the present invention can be implemented or used with other insurance concepts (e.g., accidental death, group policies).

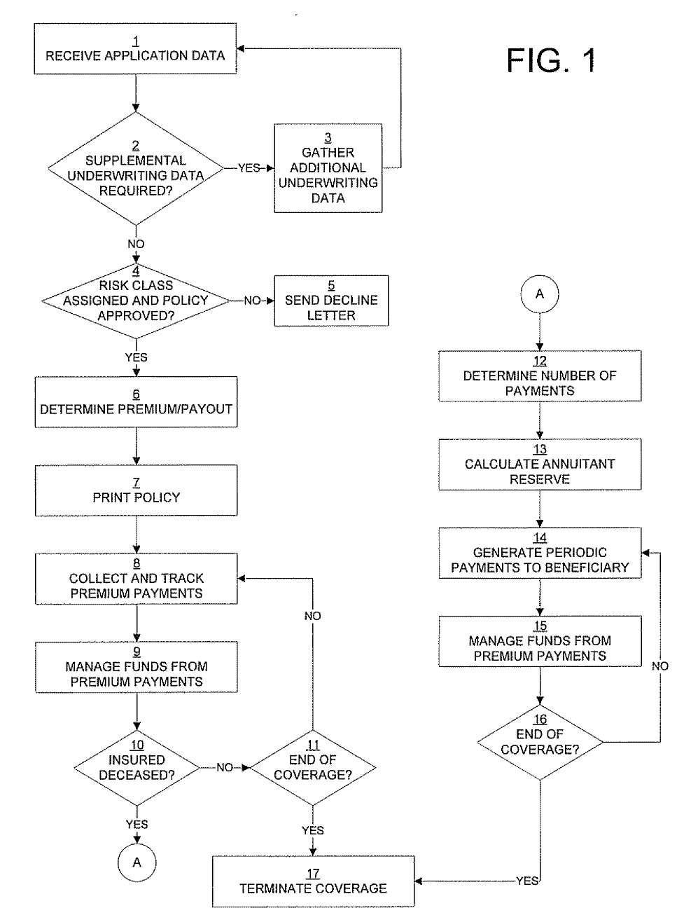

The method of the present invention will now be described with reference to the flow chart of FIG. 1. The method of the invention will be described with reference to a single, specific insured. In actual implementation there will be many such insureds, preferably sufficient to define a suitable statistical universe for conventional actuarial principles to be validly applied. In the preferred embodiments, the method includes acquiring application or underwriting data for an applicant (see block 1). Such application data will generally include identification of an insured (e.g., name, address), actuarial factors (e.g., the age and gender of the insured, medical history, smoking history), a coverage period (also referred to herein as the maximum coverage period), and a selected one of a desired premium payment and a desired periodic payout.

As to the age factor, in a particular implementation the age of the insured must be less than their expected retirement age which, in this case, is assumed to be 65. This limitation is not applicable to the broader aspects of the present invention. Also with regard to a particular implementation, the maximum coverage period is selected by the insured as the date upon which the insured expects to turn 65, but this specific time period is not limiting of the broader scope of the invention.

The applicant may select either a desired premium or a desired benefit (payout). If a desired premium is selected, then the benefit or payout that may be provided for such a desired premium is determined in the present invention. If a desired benefit payout is selected, the method of the present invention determines the corresponding premium to be paid for such a desired benefit. In a particular implementation, the premium and payout are defined as respective monthly dollar amounts; however, other respective periods and monetary denominations can be used. As to the balance of the application data, this data will include, without limitation, demographic data and responses to questions directed at customers per the underwriting requirements then in use for this product at the time of application

The application data is reviewed, and additional data needs required by the underwriting criteria are identified (see block 2). If required, additional underwriting data is collected (see block 3) using such processes as are appropriate for gathering this information from the customer or third-parties Once collected, the total data set is again reviewed to determine if additional data is required (see block 2). If no additional data is required, the application data is reviewed against underwriting guidelines, the insured is assigned to a risk class, and the policy is approved or declined based on the assigned risk class (see block 4). If appropriate, a decline letter issued (see block 5). Known actuarial and underwriting methods are used to assign the applicant to a risk class and to determine whether the policy should be approved or denied based on the assigned risk classification.

For approved applications, the method further comprises determining a payout or a premium related to the assigned risk classification, the age of the insured and the coverage period and amount (see block 6). As to the premium/payout determining illustrated at block 6, in a particular implementation a fixed minimum periodic payout is determined in response to desired periodic premium data having been selected and entered. The fixed minimum periodic payout is the guaranteed amount to be paid to the beneficiary during any time period after the death of the insured within the coverage period that has been specified in the entered data. For example, if the insured desires to pay $80.00 per month, the method determines a fixed periodic payout (e.g., $3300.00 per month) guaranteed to be paid to the beneficiary until the end of the coverage period (e.g., the 65 anniversary of the insured's birth).

If instead of the desired premium being entered a desired minimum periodic payout is selected and entered, a periodic premium to be paid for not more than the coverage period is determined. In a particular implementation, the amount of the periodic premium is fixed whereby the payment amount remains constant.

Given a desired payout or premium, the determination of the other is made. This determination is made in response to one or more of the aforementioned identification factors for the insured. For example, the age and health factors can be applied to actuarial mortality data acquired from known actuarial principles as the primary pricing factor. Although known actuarial data preprocessed into a table of specific unit prices based on age, coverage periods, assumed costs, fees and taxes, and risk classification of the insured as determined during underwriting is preferably used to implement the present invention (as in the table provided below), any specific such data, its development, and the underlying actuarial principles and equations do not form part of this invention. Thus, specific numerical data and equations referred to herein can be used in implementing the present invention but they do not define or limit the invention. In general, this data defines information about premiums and payouts in response to the age of the insured (in a particular implementation, the premium and payout data is also based on gender and health factors and other known factors). The acquired data is used to determine a specific combination of a premium and a payout in response to the acquired identifications for the respective insured/beneficiary pair. Since the premium and payout data are directly related, one can be found given the other along with the other defined parameters.

The policy may be structured such that the premium is to be paid periodically until the death of the insured, and the amount of the premium would be established partially based on this assumption. However, the policy may alternatively be structured such that the premium is to be paid periodically until the death of the beneficiary and the amount of the premium is at least partially based on this assumption. Further, the policy may have a defined coverage period (e.g., ten years) such that the premium is to be paid periodically until the end of the coverage period and the amount of the premium is at least partially based on this assumption. Alternatively, the insured may desire to pay higher premiums for a shorter period of time rather than pay lower premiums during the entire coverage period, such that the premium is to be paid periodically until the desired payment end date is reached and the amount of the premium is at least partially based on this assumption.

The actuarial data can be in the form of actuarial equations as explained above. To determine a premium, these equations are solved in response at least to the age and gender the insured. The actuarial data can be in the form of the database. The database would typically include premium amounts for respective combinations of insured age, gender, coverage period, periodic payout amount and other identification data or risk classifications if used. Examples of such data are given in the particular example at the end of this specification. This data is obtained by using the aforementioned actuarial equations.

Once the premium/payout data are known from the foregoing steps, a report or policy for the insured may be printed or otherwise provided for the insured (see block 7). A particular implementation of the printed report or policy lists the age of the insured, the beneficiary, the coverage period, the fixed periodic premium, and the fixed periodic payout. Other information, including gender and health data, can also be listed.

Premium payments are received periodically according to the policy requirements (typically monthly until the insured dies or until the coverage period ends and the policy is terminated, as illustrated in blocks 10, 11 and 17) and their receipt is tracked (see block 8) to ensure that the payment of premiums conforms to the policy requirements. The funds from the received payments are managed to ensure sufficient funds are available when needed to provide for payouts to surviving beneficiaries (see block 9). This managing function typically involved retaining, where appropriate, at least a portion of a paid premium in a financial reserve from which a future stream of payments is to be made, as well as investing a portion of the paid premium.

In a particular implementation, during the premium paying period reserves and expected benefits are calculated on the basis of the 1980 Commissioner's Standard Ordinary Mortality Table, age at last birthday, gender, and smoking history for the insured. This table provides estimates of the likelihood of benefit payout The amount of payout expected in each future period is the product of this probability and the periodic payout through the remainder of the coverage period. Both components are discounted at four percent (4.0%) in a particular implementation and are based on the current monthly payout value at issue and the specific reserve requirements then specified by the governing regulatory authority.

When it is determined that an insured has died (see block 10), the method of the present invention determines the number of payments to be paid to the beneficiary based, e.g., on the difference between date of death and a predetermined future date (e.g., the insured's planned retirement date) (see block 12). From this information, the amount of the required annuitant reserve for the policy in question is calculated (see block 13). The required annuitant reserve may be calculated as the present value of the required future payments discounted to the present at a rate of 4.0% in a particular implementation. Subsequently, payments are made to the beneficiary periodically according to the policy terms (see block 14) from funds that are managed to ensure sufficient funds are available when needed (see block 15). In a particular implementation these funds may be segregated or held in a broader pool of assets of the insuring party. After each payment it is determined whether coverage has ceased (see block 16), and if so the policy is terminated (see block 17). In one implementation, periodic monetary payments to the beneficiary may continue from the death of the insured until a predetermined future date, such as the insured's planned retirement date or a predefined coverage end date. In another implementation, payments to the beneficiary may continue until a date at which a predetermined monetary payment maximum has been provided. For example, in order to limit the risk that the insured dies soon after coverage is established thereby resulting in a long period of payments to the beneficiary, the policy may be established with predetermined maximum number of payments or maximum total payment amount. In another implementation, payments to the beneficiary may continue at least until a date at which a predetermined minimum number of monetary payments or a predetermined monetary payment minimum amount has been provided. For example, in order to limit the risk that the insured dies shortly before the predetermined future date thereby resulting in a long period of premium payments by the insured and a short period of benefit payments to the beneficiary, the policy may be established with predetermined minimum number of payments or minimum total payment amount. If, in any of the above examples, the designated beneficiary dies before the payments are to end, the payments may continue to the beneficiary's estate or an alternate beneficiary until the predetermined future date, until the predetermined monetary maximum payment has been provided, or at least until the predetermined monetary minimum payment has been provided.

Following is an example showing sample data for a database from which premium/payout data can be obtained in accordance with the present invention. Actuarial equations are also listed.

Pricing Assumptions:
Coverage Period: through age 65
Premium Paying Period: through age 65
Premium Mode: 100% Monthly
Policy Fee: $57 (to reflect amortization of market allowance)
Term: 10 year renewable to age 65
Investment Income: 4.5% net investment earnings rate

Lapse Rates:

| Policy Year | Annual Lapse Rate |
|---|---|
| 1 | 20.0% |
| 2 | 18.0% |
| 3 | 16.0% |
| 4 | 14.0% |
| 5 | 12.0% |
| 6+ | 10.0% |
| Age 65 | 100.0% |

A 5% shock lapse is applied when premiums are scheduled to increase at the end of a renewal period.

Underwriting: an underwriting manual is used to determine applicant risk classification and acceptability

Mortality:
Males: 90% of the 2001 Valuation Basic Table, ALB (age at last birthday)
Females: 95% of the 2001 Valuation Basic Table, ALB

Commissions: a commission table was produced

Expenses:
a. Acquisition:
   i. Per Policy $100—issue and underwriting
   ii. $300—marketing allowance
b. Maintenance:
   i. Percent of Premium 5%
   ii. Per Policy $25—inflating at 3% per year
   iii. Premium Tax 2.5% of premium
c. Reserves:
   i. Statutory reserves are based on the Commissioners Reserve Valuation Method (CRVM) using the 2001 Commissioners Standard Ordinary (CSO) mortality table and 4.0% interests
   ii. Tax reserves are set equal to statutory reserves
d. Cash Values: None

These assumptions yield the following pricing table which states annual premium in terms of $1000 of monthly covered income:

Annual Premium per $1,000

| | | |
|---|---|---|
| Issue/ | Non-Smoker | Smoker |

| Renewal Age | Male | Female | Male | Female |
|---|---|---|---|---|
| 20 | $254 | $151 | $378 | $204 |
| 25 | 205 | 154 | 327 | 225 |
| 30 | 218 | 168 | 369 | 259 |
| 35 | 239 | 189 | 431 | 313 |
| 40 | 291 | 237 | 556 | 421 |
| 45 | 338 | 311 | 695 | 605 |
| 50 | 379 | 334 | 770 | 694 |
| 55 | 344 | 282 | 689 | 584 |
| 60** | 298 | 248 | 632 | 464 |

**Age 60 premium is renewal only

For simplicity, the above table provides sample ages only and presumes that ages falling between these levels are either interpolated in the creation of the table or promoted to the next highest age for pricing purposes. Based on this pricing table various premium or coverage amounts may be calculated for specific approved applicants according to the general formula: P=I/12,000*p_{a,g,r}, where: P=annual premium; I=covered income; p=annual premium per $1000 of coverage; a=issue or renewal age of the insured; g=gender of the insured; and r=risk classification of the insured (such that P_{a,g,r} is the annual premium per $1000 of coverage based on the insured's age, gender, and risk classification). The resultant annual premium may be mathematically converted into an alternate periodicity (e.g. monthly) if so desired. If, on the other hand, a specific, annual premium is requested, the covered income (I) may be calculated as: I=P/p_{a,g,r}*12,000.

For example, a male non-smoker (applicant I), aged 35 who seeks to protect $50,000 in income would, if approved for coverage in this example, have a premium of: P=$50,000/(12,000)*$239=$995.83. A female smoker (applicant II), aged 45 who seeks to maximize coverage for $100 monthly premium would be able to protect an income, if approved for coverage in this example, of: I=$100*12/$605*12,000=$23,801.65.

Prior to the death of the insured, the reserves are calculated on a CRVM basis, utilizing 2001 CSO, Male/Female, Smoker/Nonsmoker mortality rates. Valuation interest rates will generally be based upon dynamic interest rates as deemed acceptable for life insurance with a guaranteed duration for the policy in question, per the minimum valuation statutes in force at the time of calculation. However, following the death of the insured the amount of capital which must be reserved for payment of the period certain annuity is typically calculated based on the general formula: Rₜ=Σb*(1+i/f)^{-j} calculated over the range from j=0 to j=x−t, where R is the required reserve for this claim; t is the number of required payments that have been made on this claim; b is the periodic benefit to be paid on this claim (I/f); i is the then discount rate then in force (see above); x is the total number of payments to the beneficiary in the claim in question; and f is the periodicity of the claim payments (ergo, monthly). In one implementation, x will be based on the formula (A−a)*f, in which a=the insured's age at death, A=the age to which he or she was insured, and f=the frequency of income distribution required under the policy

For applicant I (in the example above), this required reserve under a discount rate of 4% (i=4%) after 5 monthly claims payments (t=5) have been made following his death at aged 51 years and 6 months is determined as follows:

x=(A−a)*f=(65−51.5)*12=162;

b=I/f=$50,000/12=$4,166.67; and

R=Σb*(1+i/f)^{-j}=$508,677.88.

### For applicant II (in the example above) the required reserve calculated using the same assumptions is $242,147.26.

FIG. 1 and the associated description above illustrate an embodiment of the invention in which the amounts of the premium payments and beneficiary payments are determined and fixed at the time of policy approval. In alternative embodiments of the invention, either or both of the premium payments and the beneficiary payments may be revised during the coverage period. For example, the amount of the beneficiary payments may be periodically revised between the time of policy approval and the date of death of the insured, and then may be fixed at the date of death of the insured. Alternatively, the amount of the beneficiary payments may be periodically revised during the entire coverage period (i.e., until the date of death of the beneficiary). Typically, the periodic premium amount will be revised if the amount of the periodic monetary payments is revised. However, the premium payment may be fixed at a higher amount during the entire coverage period to provide beneficiary payments that are permitted to vary based on, for example, the rate of inflation.

The revisions to the amount of beneficiary payments may be based on a number of different factors, such as changes in the income of the insured, changes in the amount of a paycheck of the insured, changes in the amount deposited into a direct deposit account of the insured, changes in an expense of the insured, or actual or anticipated inflation rate.

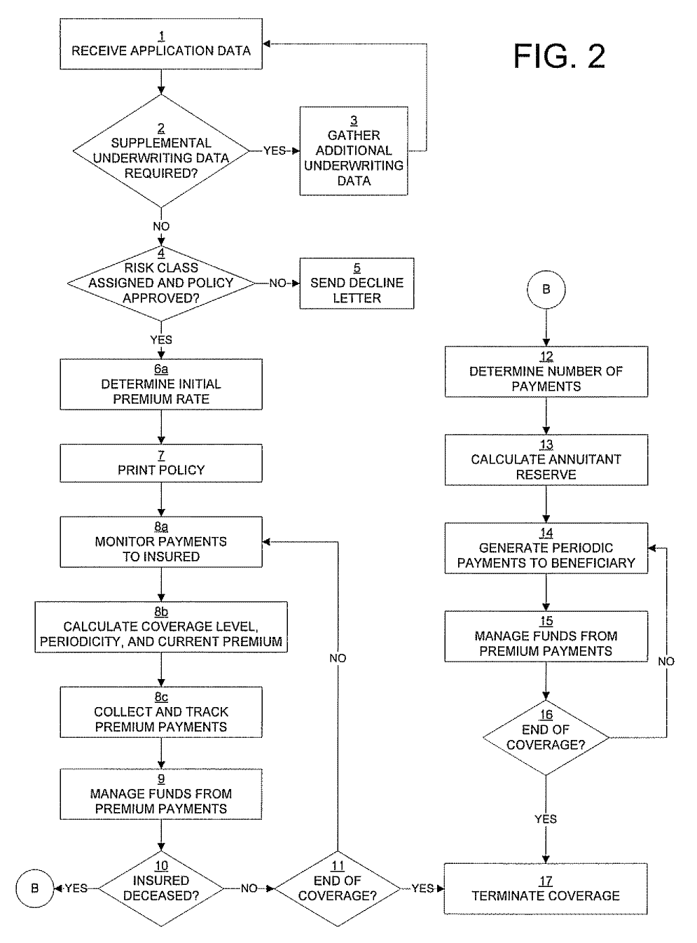

Referring now to FIG. 2, a flow chart of a method for providing a periodic income stream is illustrated, in accordance with an alternative embodiment of the present invention. As with the implementation illustrated in FIG. 1, in the method illustrated in FIG. 2 the initial premiums are set at the time of policy approval (in the case of an individual policy) or at the time of enrollment (in the case of a group product, described further below) (see block 6a). In the event of a series of one or more missed payments which, in total, fall outside the company's reinstatement policy, this process of setting the initial premium may be repeated to reflect a new underwriting decision.

Once a policy or enrollment is approved, on-going premiums are calculated based on the amount of a paycheck of the insured or amount deposited into a direct deposit account of the insured. The premium is typically calculated based on the size of the payment to be covered, the periodicity (frequency of such payments) and the then-current premium rate per dollar of coverage for that periodicity (see block 8b). Benefits and reserves will generally be calculated based on the weighted average of some number of recent payments—typically twelve months for policies in force greater than one year and to-date for policies in place less than one year.

In order to properly calculate the premiums on an on-going basis, the payments to the insured upon which coverage is based need to be monitored (see block 8a). This monitoring is typically handled by either the employer, a proxy of the employer (e.g., a payroll service company), or the financial institution to which deposits are made. Each payment must fall within the type of payments covered in the policy (e.g., payroll deposits, but not social security payments or disability payments). Covered hazards may be full life (i.e., coverage exists for any cause of death) or a more limited set of exposures (e.g., accidental death). In addition, exceptional deposits such as those made in the event of a severance or bonuses may not be covered, and if covered may be subject to modification to normalize coverage over the base periodicity. For example, if someone receives $4,000 per check twice a month and then receives an exceptional bonus of $40,000 once a year, coverage will typically be adjusted either by excluding the bonus from coverage and premiums or by calculating coverage based on the annual average income. The remainder of the method of FIG. 2 (blocks 8c through 17) is the same as for the method of FIG. 1.

In an alternative embodiment of the invention, the determination of the periodic premium amount provides for the payment of a mathematical sum of all received payments of the premium amount if the insured survives past a predetermined date. This is referred to a return of premium feature or rider.

In one embodiment of the invention, the policy is provided to a group of associated individuals, such as employees of a company. In such a method, a plurality of actuarial factors are identified for a plurality of insureds, and a periodic premium amount is determined which may be sufficient to enable provision of periodic monetary payments to a respective beneficiary beginning at a death of a respective insured and ending at a predetermined future date. In another embodiment, individual demographic and actuarial factors are used in addition to the group actuarial data determine premiums. In either case, payments of the determined premium amount may be received from a payor associated with all of the plurality of insureds (e.g., the employer of the insureds).

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing periodic monetary payments to a beneficiary who survives an insured, the method comprising:
identifying a plurality of actuarial factors for the insured;
determining for the insured, by correlating actuarial mortality data with the identified actuarial factors, a periodic premium amount sufficient to enable provision of periodic monetary payments to the beneficiary beginning at a death of the insured and ending at a predetermined future date;
receiving, periodically, payments of the determined premium amount;
determining a date of death of the insured; and
providing periodic monetary payments to the beneficiary until the earlier of (1) the predetermined future date or (2) a date at which a predetermined monetary payment maximum has been provided.

2. The method of claim 1, wherein the periodic monetary payments are further provided at least until a date at which a predetermined monetary payment minimum amount has been provided or until a date at which a predetermined minimum number of monetary payments has been provided.

3. The method of claim 1, wherein the premium amount is received periodically until the earliest of the date of death of the insured, the date of death of the beneficiary, a coverage period end date, or a desired payment end date.

4. The method of claim 1, further comprising:
retaining at least a portion of the received premium payments in a financial reserve from which the periodic monetary payments is made.

5. The method of claim 1, wherein the predetermined monetary payment maximum corresponds to one of a predetermined maximum number of payments or a predetermined maximum total payment amount.

6. The method of claim 1, wherein the predetermined future date corresponds to a predetermined retirement age of the insured.

7. The method of claim 1, wherein the periodic monetary payments are based on at least one of (1) an income of the insured, (2) an amount of a paycheck of the insured, (3) an amount deposited into a direct deposit account of the insured, or (4) an expense of the insured.

8. The method of claim 7, wherein an amount of the periodic monetary payments to be provided to the beneficiary is either (1) determined and fixed at a time when the periodic premium amount is determined, (2) periodically revised between the time when the periodic premium amount is determined and the date of death of the insured and fixed at the date of death of the insured, (3) periodically revised until the date of death of the beneficiary.

9. The method of claim 8, wherein the periodic revisions are based on at least one of (1) changes in the income of the insured, (2) changes in the amount of the paycheck of the insured, (3) changes in the amount deposited into a direct deposit account of the insured, (4) changes in the expense of the insured, or (5) inflation.

10. The method of claim 8, further comprising:
revising the periodic premium amount if the amount of the periodic monetary payments is revised.

11. The method of claim 1, wherein the determination of the periodic premium amount provides for the payment of a mathematical sum of all received payments of the premium amount if the insured survives past a predetermined date.

12. The method of claim 1, wherein a plurality of actuarial factors are identified for a plurality of insureds; wherein a periodic premium amount is determined sufficient to enable provision of periodic monetary payments to a respective beneficiary beginning at a death of a respective insured and ending at a predetermined future date.

13. The method of claim 12, wherein payments of the determined premium amount are received from a payor associated with all of the plurality of insureds.

14. The method of claim 13, wherein the actuarial data used in determining the premium amount includes data regarding a group with which the plurality of insureds is associated.

15. A method of providing periodic monetary payments to a beneficiary who survives an insured, the method comprising:
identifying a plurality of actuarial factors for the insured;
identifying, from the insured, a desired periodic premium amount;
determining for the insured, by correlating actuarial mortality data with the identified actuarial factors, a periodic monetary payment amount to be provided to the beneficiary beginning at a death of the insured and ending at a predetermined future date;
receiving, periodically, payments of the identified premium amount;
determining a date of death of the insured; and
providing the determined periodic monetary payments to the beneficiary until the earlier of (1) the predetermined future date (2) a date at which a predetermined monetary payment maximum has been provided.

16. The method of claim 15, wherein the determined periodic monetary payments are further provided at least until a date at which a predetermined monetary payment minimum amount has been provided or until a date at which a predetermined minimum number of monetary payments has been provided.

17. The method of claim 15, wherein the premium amount is received periodically until the earliest of the date of death of the insured, the date of death of the beneficiary, a coverage period end date, or a desired payment end date.

18. The method of claim 15, further comprising:
retaining at least a portion of the received premium payments in a financial reserve from which the periodic monetary payments is made.

19. The method of claim 15, wherein the predetermined monetary payment maximum corresponds to one of a predetermined maximum number of payments or a predetermined maximum total payment amount.

20. The method of claim 15, wherein the predetermined future date corresponds to a predetermined retirement age of the insured.
